(19) United States
(12) Patent Application Publication
(10) Pub. No.: US 2003/0048916 A1
(43) Pub. Date: Mar. 13, 2003

(54) Earphone transfer coupling apparatus

(76) Inventor: Chin Ding Chen, Taipei City (TW)

Correspondence Address: BACON & THOMAS, PLLC, 625 Slaters Lane, 4th Floor, Alexandria, VA, 22314-1176, US

(21) Appl. No.: 09/950,678

(22) Filed: Sep. 13, 2001

(51) Int. Cl. H04R 25/00

(52) U.S. Cl. 381/374; 381/322

(57) ABSTRACT

An improved earphone transfer coupling apparatus includes a transfer element and a clip element. After the transfer element is fastened to the clip element, the transfer element may be coupled with an earphone to allow the transfer coupling apparatus inserted in user's ear or clipped on user's ear auricle.

### FIELD OF THE INVENTION

The present invention relates to an improved earphone transfer coupling apparatus and particularly a transfer coupling apparatus that is insertable into a human ear and allows to clip on the ear.

### BACKGROUND OF THE INVENTION

Hand-free handsets have been widely used with mobile phones these days. They are especially useful and convenient for drivers to make phone calls without using hands to hold the mobile phones.

When using the hand-free handset, the connector of the hand-free handset is linked to the mobile phone while the connector has one end attached to a conductive line linking to an earphone for inserting into the external auditory canal of an user's ear. When there is incoming call from the mobile phone, the mobile phone transmits incoming audio signals to the earphone, and user's speaking audio signals are received by the receiver attached to the conductive line for transmitting to the mobile phone for emission. Users thus may make conversation without holding the mobile phones.

However the earphone tends to get loose and drop when an user's external auditory canal is too large relative to the earphone, or the earphone cannot be fully inserted into the external auditory canal when user's external auditory canal is too small relative to the earphone, in the later occasion, trying to insert the earphone into the external auditory canal by force will hurt user's ear.

Some producers have developed a transfer coupling means 1a (as shown in FIG. 1) made of soft rubber to fix this problem. The transfer coupling means 1a has a coupling section 2a to engage with the earphone 3a and may be directly inserted into user's external auditory canal. As the transfer coupling means is made of soft rubber, it can be held into the external auditory canal securely without hurting user's ear. However, a specific transfer coupling means la must be made to match a specific earphone 3a, and one set of transfer coupling means usually cannot match different brands of hand-free earphone. As a result, users have to buy the transfer coupling means la with the hand-free earphones. It is not convenient.

### SUMMARY OF THE INVENTION

The primary object of the invention is resolve the foregoing disadvantages. The invention provides a transfer coupling apparatus that may be directly held in user's ear and allows to couple with different brands of hand-free earphone.

Another object of the invention is to provide a transfer coupling apparatus adaptable to different inner shapes of ears to suit different users. Yet another object of the invention is to provide a transfer coupling apparatus of different sizes to suit different sizes of users' ears.

To attain aforesaid objects, the transfer coupling apparatus of the invention consists of a transfer element and a clip element. The transfer element includes a jutting section insertable into the ear and a coupling section. The jutting section has at least a first jutting section and a second jutting section with a through aperture formed in the second jutting section. The coupling section is hollow and communicates with the aperture. The clip element has a hook which has one end attached to a pivotal section to pivotally engage with a pivotal bore formed in the transfer element. After the transfer element and clip element is assembled, and the coupling section is engaged with the earphone, the transfer coupling apparatus may be inserted into user's ear and clipped on the auricle of the ear.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional earphone transfer coupling means.

FIG. 2 is a perspective view of the invention.

FIG. 3 is a front view of the invention according to FIG. 2.

FIG. 4 is a cross section of the invention taken along line 4-4 of FIG. 3.

FIG. 5 is a schematic view of the invention in use.

FIG. 6 is a schematic view of another embodiment of the invention.

FIG. 7 is a schematic view of yet another embodiment of the invention.

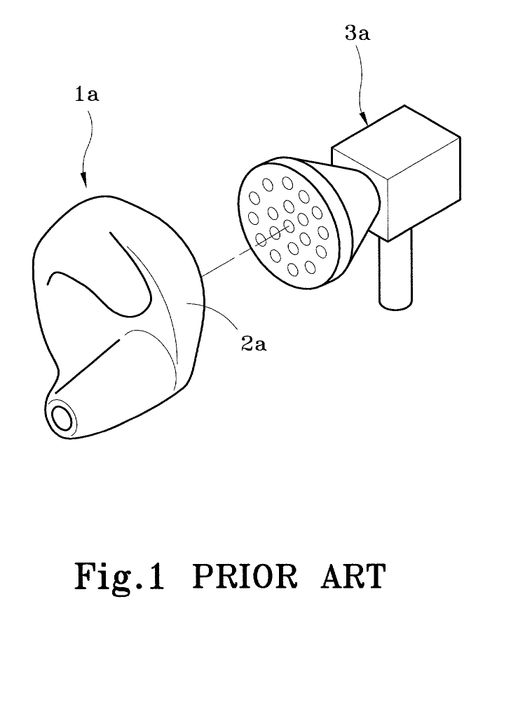

### DESCRIPTION OF THE PREFERRED EMBODIMENTS

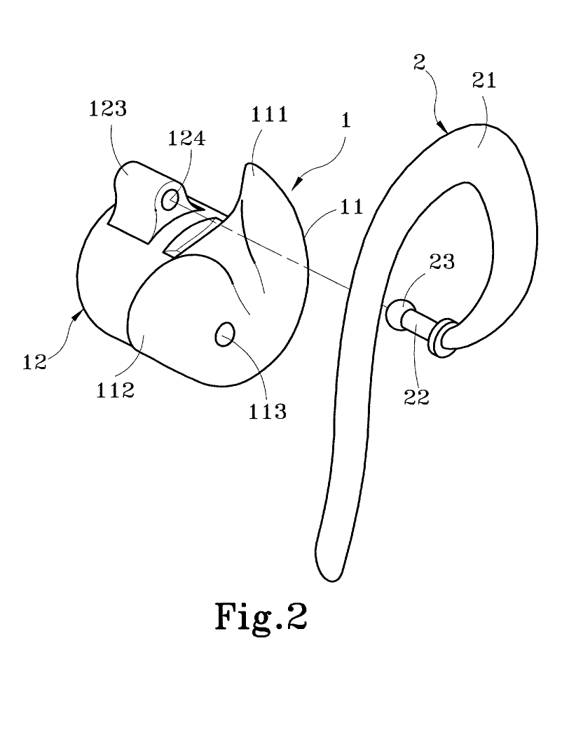

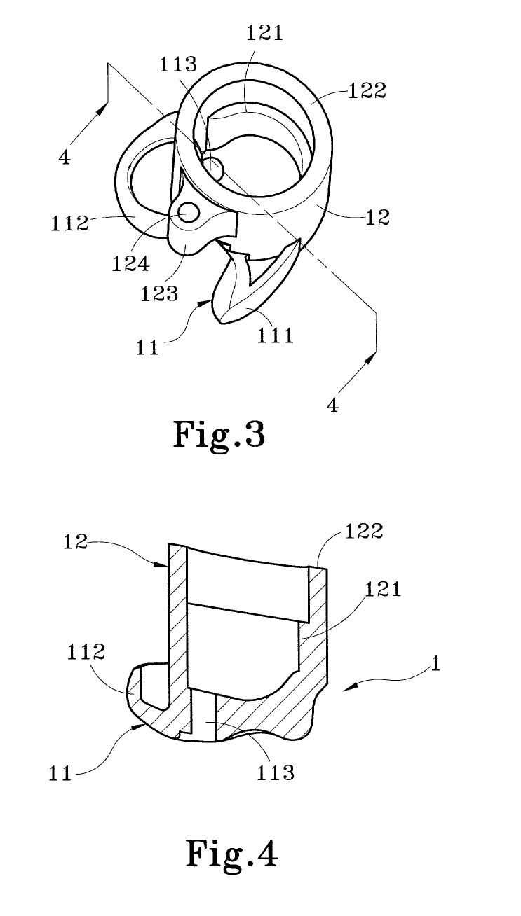

Referring to FIGS. 2, 3 and 4, the earphone transfer coupling apparatus of the invention consists of a transfer element 1 and a clip element 2 made of a soft rubber with the exterior contour conforming to ergonomics and is insertable into users' ear when in use.

The transfer element 1 has a jutting section 11 and a coupling section 12 located at one side of the jutting section 11. The jutting section 11 further includes a first jutting section 111 and a second jutting section 112 of different shapes for inserting in the external auditory canal and scapha of an user's ear. The second jutting section 112 further has a through aperture 113 formed therein for audio signal output. The coupling section 12 is attached to another side of the jutting section 11 and is hollow and communicates with the aperture 113 of the second jutting section 112. When the coupling section 12 is engaged to the earphone (not shown in the drawings), audio signals output from the earphone will be transmitted through the aperture 113 of the second jutting section 112. The coupling section 12 has an audio filter 121 located therein to filter out ambient noises to allow audio signals outputting clearly through the aperture 113. The coupling section 12 further has a sloped opening rim 122 such that when the coupling section 12 is engaged with the earphone, the receiver (not shown in the drawings) of the earphone may be tilted closely to user's cheek to receive user's speaking audio signal more effectively. The coupling section 12 further may have a lug 124 jutting outwards from the peripheral surface. The lug 124 has a pivotal bore 124 formed therein.

The clip element 2 includes a hook 21 for clipping the apparatus on user's ear. The hook 21 has one end attached to a pivotal section 22 to engage with the pivotal bore 124. The pivotal section 22 has a curvy retain section 23 to allow the pivotal section 22 engaging with the pivotal bore 124 securely without loosening off.

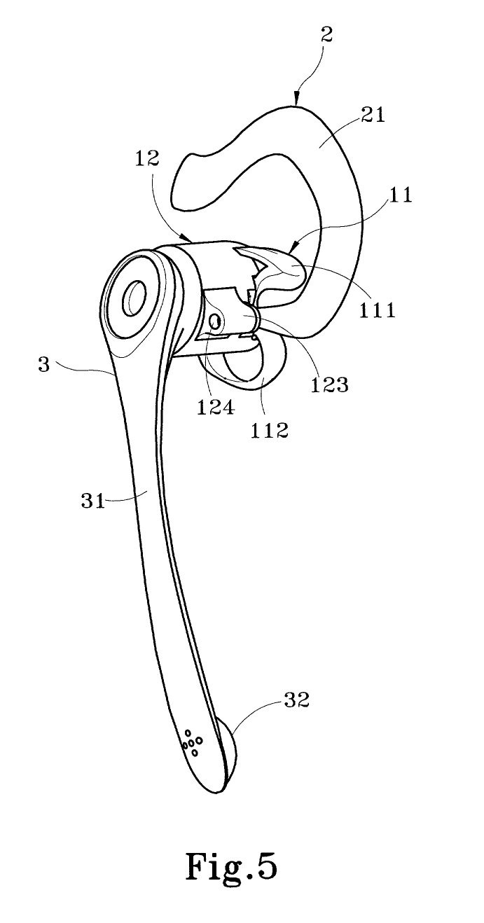

Referring to FIG. 5, when in use, the earphone 3 is engaged with the coupling section 12. The first and second jutting section 111, 112 may be disposed into external auditory canal and scapha of user's ear to allow the transfer element 1 held in the ear securely. The sloped opening rim 122 of the coupling section 12 allows the extension arm 31 of the earphone 3 positioning closely to user's cheek so that the receiver 32 of the earphone 3 can effectively capture user's speaking audio signals.

In the event that the jutting section 11 of the transfer element 1 cannot be held securely in the ear, the transfer element 1 may be pivotally engaged with the clip element 2. And the hook 21 may be turned to clip on the ear auricle to allow the transfer element 1 held securely in the ear.

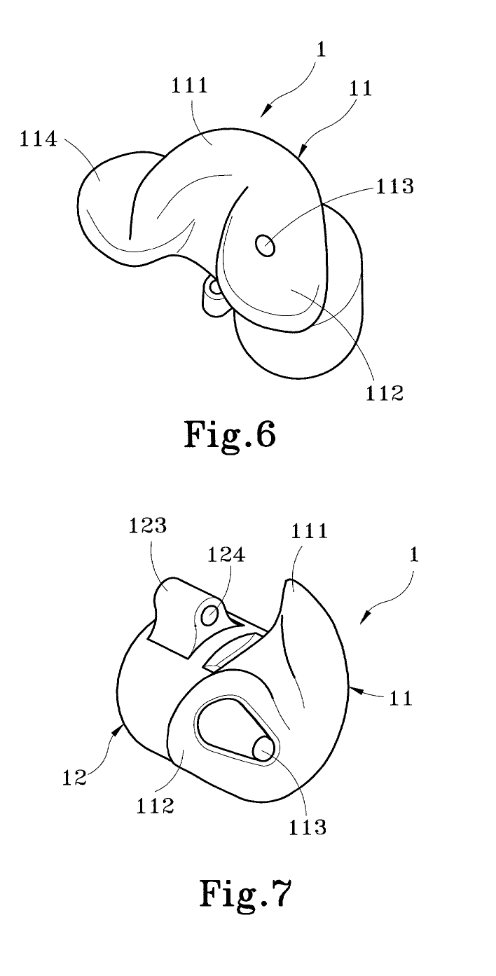

Referring to FIG. 6 for another embodiment of the invention which is largely similar to the embodiment previously discussed, however the jutting section 12 has a first jutting section 111, a second jutting section 112 and a third jutting section 114 to suit different ear inner contours of different users, and offer users more selections.

Referring to FIG. 7 for yet another embodiment of the invention which also is largely similar to the embodiment previously discussed, however the second jutting section 112 has an indented recess 115 formed on the peripheral surface surrounding the aperture 113 for converging and amplifying audio signals to user's ear to allow user getting clearer audio signals.

Furthermore, the transfer coupling apparatus of the invention may be made in different sizes to suit different inner sizes of users' ears. The hollow space of the coupling section 12 is adaptable to different hand-free earphones.

In addition, the sloped opening rim 122 may have a notch to facilitate engagement with the coupling section or make adjustment of the earphone position easier.

What is claimed is:

1. An improved earphone transfer coupling apparatus insertable into an user's ear for coupling with an earphone, comprising:
a transfer element having a jutting section and a coupling section located at one side of the jutting section, the jutting section including at least a first jutting section and a second jutting section, which has a through aperture formed therein; the coupling section being hollow and communicating with the aperture;
wherein the coupling section is engageable with the earphone and the transfer coupling apparatus is insertable in user's ear.

2. The improved earphone transfer coupling apparatus of claim 1, wherein the coupling section has an audio filter located therein for filtering out ambient noises.

3. The improved earphone transfer coupling apparatus of claim 1, wherein the coupling section has a sloped opening rim.

4. The improved earphone transfer coupling apparatus of claim 1, wherein the second jutting section has an indented recess formed on the peripheral surface surrounding the aperture for converging and amplifying audio signals to user's ear.

5. The improved earphone transfer coupling apparatus of claim 1, wherein the transfer coupling apparatus is made in different sizes to fit different inner sizes of users' ears.

6. The improved earphone transfer coupling apparatus of claim 1, wherein the coupling section is hollow and engageable with different hand-free earphones.

7. The improved earphone transfer coupling apparatus of claim 1, wherein the sloped opening rim of the coupling section has a notch to facilitate coupling with the earphone or adjusting the position of the earphone.

8. The improved earphone transfer coupling apparatus of claim 1, wherein the jutting section has a first jutting section, a second jutting section and a third jutting section to fit different interior shapes of users' ears.

9. An improved earphone transfer coupling apparatus insertable into an user's ear for coupling with an earphone, comprising:
a transfer element having a jutting section and a coupling section located at one side of the jutting section, the jutting section including at least a first jutting section and a second jutting section which has a through aperture formed therein, the coupling section being hollow and communicating with the aperture, the coupling section having a jutting lug extended from the exterior surface with a pivotal bore formed therein; and
a clip element having a hook, the hook having one end attached to a pivotal section engageable with the pivotal opening;
wherein the transfer element is fastened to the clip element for the coupling section to engage with the earphone such that the transfer coupling apparatus is insertable in user's ear and allowed to clip on user's ear auricle.

10. The improved earphone transfer coupling apparatus of claim 9, wherein the pivotal section has a retain section.

11. The improved earphone transfer coupling apparatus of claim 10, wherein the retain section is formed in a curvy shape.
